(19) United States
(12) Patent Application Publication
(10) Pub. No.: US 2026/0268755 A1
(43) Pub. Date: Sep. 10, 2026

(54) BED FALL WARNING METHOD BASED ON MILLIMETER WAVE RADAR

(71) Applicant: Tinglan Technology (Shenzhen) Co., Ltd., Shenzhen (CN)

(72) Inventors: Yilin SUN, Shenzhen (CN); Donghong HUANG, Shenzhen (CN)

(73) Assignee: Tinglan Technology (Shenzhen) Co., Ltd., Shenzhen (CN)

(21) Appl. No.: 19/658,731

(22) Filed: Apr. 27, 2026

Related U.S. Application Data
(63) Continuation of application No. PCT/CN2024/072566, filed on Jan. 16, 2024.

(30) Foreign Application Priority Data
Oct. 25, 2023 (CN) 2023113872591

(51) Int. Cl. G08B 21/04; G01S 7/35; G01S 13/34; G01S 13/89

(52) U.S. Cl. CPC G08B 21/043; G01S 7/354; G01S 7/356; G01S 13/34; G01S 13/89; G08B 21/0469

(57) ABSTRACT

The present invention discloses a falling bed warning method, system, and computer-readable storage medium based on millimeter wave radar. The method comprises: receiving echo signals in space, and calculating point cloud data of a monitoring object based on the echo signals; Determine whether the monitoring object has a tendency to move towards the outside of the bed based on the point cloud data; Determine whether the monitoring object is in the preset falling bed warning position based on the point cloud data; If the monitoring object has a tendency to move towards the edge of the bed and is in the preset falling bed alarm position, execute the set falling bed warning instruction. The falling bed warning method based on millimeter wave radar of the present invention has the advantages of privacy protection, all-weather monitoring, contactless monitoring, high recognition accuracy, and convenient installation.

### CROSS-REFERENCE TO RELATED APPLICATIONS

The application claims priority to Chinese patent application No. 2023113872591, filed o Oct. 25, 2023, the entire contents of which are incorporated herein by reference.

### TECHNICAL FIELD

The present invention relates to the field of falling bed warning technology, particularly to a falling bed warning method, system, and computer-readable storage medium based on millimeter wave radar.

### BACKGROUND

With the trend of aging population, the demand for elderly care services is increasing, but the resources for elderly care services are relatively scarce. Especially for bedridden patients, due to physical weakness or unclear consciousness, they are prone to falling off the bed, causing injury or death. Therefore, how to effectively prevent and timely detect bed falling incidents of bedridden patients is an urgent problem to be solved.

At present, there are several common bed fall warning schemes:
1. A solution based on pressure sensors: This solution involves installing pressure sensors on mattresses or bed sheets to detect changes in the user's weight and determine whether a bed fall event has occurred. The disadvantage of this solution is that: firstly, the pressure sensor is easily affected by environmental factors such as temperature and humidity, leading to measurement errors; Secondly, pressure sensors require direct contact with users, which may affect their comfort and sleep quality; The third issue is that pressure sensors cannot distinguish between normal turning and abnormal bed falling behavior of users, which can easily result in false alarms or missed reports.
2. A solution based on wearable devices: This solution involves wearing wearable devices such as wristbands, watches, etc. on the user's body, and detecting physiological signals such as posture, movement, and heart rate to determine whether a bed fall event has occurred. The disadvantages of this approach are: firstly, wearable devices require continuous contact with users, which may cause discomfort or allergic reactions; Secondly, wearable devices require regular charging or battery replacement, which may cause inconvenience or interruption in use.

Based on the shortcomings of the current bed fall warning scheme, it is urgent to propose a bed fall warning method that can be monitored 24/7 and has no contact.

### SUMMARY

The present embodiment provides a falling bed warning method based on millimeter wave radar, aiming to achieve all-weather and contactless falling bed warning monitoring.

To achieve the above objectives, the embodiments of the present application provide a falling bed warning method based on millimeter wave radar, comprising:
Receive echo signals in space and calculate point cloud data of the monitoring object based on the echo signals;
Determine whether the monitoring object has a tendency to move towards the outside of the bed based on the point cloud data;
Determine whether the monitoring object is in the preset falling bed warning position based on the point cloud data;
If the monitoring object has a tendency to move towards the edge of the bed and is in the preset falling bed alarm position, execute the set falling bed warning instruction.

In one embodiment, calculating the point cloud data of the monitoring object based on the echo signal comprises:
Convert the echo signal into a digital signal;
Perform distance dimension fast Fourier transform and Doppler dimension Fourier transform on the digital signal to obtain the distance Doppler spectra of all virtual channels of the radar;
Perform incoherent accumulation on the distance Doppler spectra of all virtual channels, and use preset threshold parameters to perform two-dimensional constant false alarm detection on the accumulated results, in order to extract the corresponding target units of the monitoring object on the distance Doppler spectra;
Perform joint azimuth elevation angle measurement on the target unit corresponding to the monitoring object to obtain the azimuth and elevation angles of the target unit;
Obtain point data corresponding to the target unit in space based on the azimuth and elevation angles, as well as the corresponding distance units on the range Doppler spectrum;
Generate point cloud data for the monitoring object based on all point data of the monitoring object.

In one embodiment, determining whether the monitoring object has a movement trend towards the outside of the bed based on the point cloud data includes:
Cluster and fuse the point cloud data of the monitoring object to obtain the fitting center of the monitoring object in space;
Perform Kalman filtering tracking on the fitting center to obtain the historical movement trajectory of the monitoring object;
Determine whether the monitoring object has a tendency to move towards the outside of the bed based on the historical movement trajectory.

In one embodiment, determining whether the monitoring object has a tendency to move towards the outside of the bed based on the historical movement trajectory includes:
Calculate the distance between the monitoring object and the designated boundary of the bed based on the historical movement trajectory;
Determine whether the monitoring object is moving towards the designated boundary of the bed based on the distance provided;
If the monitoring object continuously or intermittently moves towards the designated boundary of the bed within a set time, and the movement distance exceeds the preset distance threshold, it is determined that the monitoring object has a tendency to move towards the outside of the bed.

In one embodiment, a falling bed warning area is pre-set at the boundary of the bed;

Judging whether the monitoring object is in the preset falling bed alarm position based on the point cloud data, including:
Calculate the number of monitoring points located within the falling bed warning area in the point cloud data of the monitoring object;
Calculate the ratio of the number of monitoring points located within the falling bed warning area to the total number of monitoring points in the point cloud data of the monitoring object, and compare the ratio with a preset threshold; If the ratio is greater than or equal to the preset threshold, it is determined that the monitoring object is currently in the preset falling bed alarm position.

In one embodiment, before determining whether the bedridden patient is in the preset falling bed alarm position based on point cloud data, the method further comprises:
Receive user instructions through a preset user graphical interface, including instructions for setting the boundary of the bed and instructions for setting the warning area for falling beds;
Based on the received user instructions, specify the boundary of the bed in the space and delineate a falling bed warning area within the boundary of the bed.

In one embodiment, after executing the set falling bed warning instruction, the method further comprises:
Determine whether the monitoring object has experienced a bed falling event based on its point cloud data;
If a falling bed event is detected in the monitored object, execute the set falling bed alarm command.

In one embodiment, executing the set falling bed warning instruction includes sending falling bed warning information to pre bound users; And/or
Executing the set falling bed alarm command includes sending falling bed alarm information to pre bound users.

To achieve the above objectives, the embodiments of the present application also propose a falling bed warning system based on millimeter wave radar, comprising a memory, a processor, and a falling bed warning program based on millimeter wave radar stored on the memory and executable on the processor. When the processor executes the falling bed warning program based on millimeter wave radar, it implements any of the falling bed warning methods based on millimeter wave radar as described above.

To achieve the above objectives, the embodiments of the present application also propose a computer-readable storage medium, which stores a falling bed warning program based on millimeter wave radar. When the falling bed warning program based on millimeter wave radar is executed by a processor, it implements any of the falling bed warning methods based on millimeter wave radar as described above.

The falling bed warning method based on millimeter wave radar in the technical solution of this application obtains point cloud data of the monitoring object through radar to calculate the monitoring movement trend and current position. When the monitoring object has a movement trend towards the outside of the bed and is in the falling bed warning position, it determines that the monitoring object has a falling bed risk and executes the falling bed warning instruction, thereby achieving the falling bed warning of the monitoring object. Therefore, compared to the traditional solution of detecting bed falls through smart wearable devices, the technical solution of this application has the following advantages:
1. Privacy protection: Unlike cameras, millimeter wave radar does not generate images during monitoring, but only captures simple trajectories and point cloud data. This means that the privacy of the monitored object has been effectively protected and will not touch upon personal privacy issues. This makes the bed fall detection system very suitable for private places such as bedrooms and wards.
2. 24/7 monitoring: Millimeter wave radar can monitor under all weather conditions, without being limited by light, temperature, or weather conditions. This makes the bed fall detection system highly suitable for people who require round the clock monitoring, such as the elderly and children.
3. Contactless monitoring: The system uses millimeter wave radar for contactless monitoring, without the need for monitoring objects to wear special equipment. This reduces the burden on users, especially for the elderly and children who do not need to wear additional smart devices.
4. High recognition accuracy: At the same time, the monitoring object's risk of falling from the bed can be determined by the movement trend and the location of the falling bed warning, which can minimize the probability of false alarms and improve the accuracy of the falling bed warning.
5. Easy installation: The installation of millimeter wave radar is very convenient, it can be installed on the top of the ceiling or at the head of the bed, and the setup is simple. This allows users to easily deploy the system without the need for complex installation processes, reducing barriers to use.

### BRIEF DESCRIPTION OF DRAWINGS

In order to provide a clearer explanation of the embodiments of the present invention or the technical solutions in the prior art, a brief introduction will be given to the accompanying drawings required for the description of the embodiments or the prior art. It is obvious that the accompanying drawings described below are only some embodiments of the present invention. For those skilled in the art, other drawings can be obtained based on the structures shown in these drawings without creative labor.

FIG. 1 is a module structure diagram of an embodiment of a falling bed warning system based on millimeter wave radar according to the present invention;

FIG. 2 is a flowchart of an embodiment of a falling bed warning method based on millimeter wave radar according to the present invention;

FIG. 3 is a schematic diagram of the module for obtaining the point cloud distribution of the monitoring object in the falling bed warning method based on millimeter wave radar of the present invention;

FIG. 4 is a schematic diagram of the module for calculating the historical movement trajectory of the monitoring object in the falling bed warning method based on millimeter wave radar of the present invention;

FIG. 5 is a schematic diagram of the module used in the millimeter wave radar based falling bed warning method of the present invention to determine whether the monitored object is in the preset falling bed warning position;

FIG. 6 is a flowchart of another embodiment of a falling bed warning method based on millimeter wave radar according to the present invention.

The implementation, functional characteristics, and advantages of the present invention will be further explained with reference to the accompanying drawings in conjunction with the embodiments.

### DETAILED DESCRIPTION OF THE EMBODIMENTS

It should be understood that the specific embodiments described herein are only used to explain the present invention and are not intended to limit the present invention.

In order to better understand the above technical solution, the exemplary embodiments of the present disclosure will be described in more detail below with reference to the accompanying drawings. Although exemplary embodiments of the present disclosure are shown in the accompanying drawings, it should be understood that the present disclosure may be implemented in various forms and should not be limited by the embodiments described herein. On the contrary, these embodiments are provided to enable a more thorough understanding of this disclosure and to fully convey the scope of this disclosure to those skilled in the art.

It should be noted that any reference symbols located between parentheses should not be constructed as limitations on the claims. The use of “including” in the text does not exclude the existence of components or steps that are not listed in the claims. The quantity word ‘one’ or ‘one’ before the component does not exclude the existence of multiple such components. The present invention can be implemented by means of hardware comprising several different components and by means of a properly programmed computer. In the unit claims listing several devices, several of these devices may be specifically embodied through the same hardware item. The use of words such as ‘first’, ‘second’, and ‘third’ does not indicate any order and can be interpreted as names.

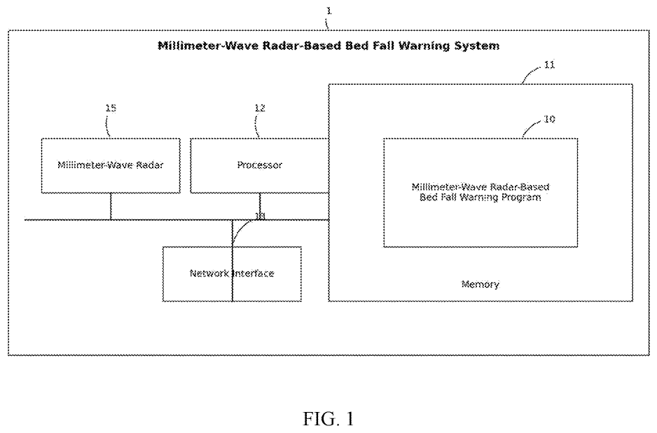

As shown in FIG. 1, FIG. 1 is a schematic diagram of the structure of a falling bed warning system based on millimeter wave radar according to an embodiment of the present invention.

As shown in FIG. 1, the server 1 includes: millimeter wave radar 15, memory 11, processor 12, and network interface 13.

In this embodiment, the radar of the present invention adopts TD-MIMO (Instant Division Multiple Access Multiple Input Multiple Output) signal transmission mode, transmitting a linear frequency modulated continuous wave signal (chirp signal). The radar signal is transmitted by the transmitting antenna, and the transmitted electromagnetic wave signal encounters obstacles and is reflected back. After time, the receiving antenna receives the echo signal, passes through a low-noise amplifier to filter out noise influence, and then mixes with one of the transmitting signals. After passing through a low-pass filter, the intermediate frequency signal (IF signal) is obtained. The ADC signal can be obtained by digital sampling of the intermediate frequency signal. The frequency of the intermediate frequency signal is:, where k is the frequency modulation slope of the signal, is the target delay, and the delay is related to the target distance d as follows: For the target distance, c is the speed of light. Therefore, the distance between the target and the radar can be obtained from the frequency of the intermediate frequency signal. τ ƒ_{IF} ƒ_{IF}−k*τ_{ττ τ}−2d/c ƒ_{IF}=k*τ=k2d/c

Furthermore, the millimeter wave radar of the present invention adopts a design of 3 transmitting and 4 receiving antennas, with 3 transmitting antennas transmitting signals in a time-division multiplexing manner and 4 receiving antennas simultaneously receiving signals. Each transmitting antenna sends 32 chips in one frame, with 512 ADC sampling points per chip. I/Q complex sampling is used, and the amount of ADC data received in one frame is 12*32*512*2.

Optionally, there are two installation methods for the radar of the present invention, namely top mounted and side mounted. The top mounted radar is installed on the ceiling or suspended ceiling directly above the bed, while the side mounted radar is installed in the middle position above the bed head, within a range of 1.5 m to 1.8 m from the ground.

Furthermore, the memory 11 may also include internal storage units of the server 1 as well as external storage devices. Memory 11 can not only be used to store application software and various data installed on server 1, such as the code of the millimeter wave radar based falling bed warning program 10, but also temporarily store data that has been or will be output.

In some embodiments, processor 12 may be a Central Processing Unit (CPU), controller, microcontroller, microprocessor, or other data processing chip used to run program code stored in memory 11 or process data, such as executing millimeter wave radar based fall warning program 10, etc.

Network interface 13 can optionally include standard wired interfaces and wireless interfaces (such as WI-FI interfaces), typically used to establish communication connections between server 1 and other electronic devices.

The network can be Internet, cloud network, Wi Fi network, personal network (PAN), local area network (LAN) and/or metropolitan area network (MAN). Various devices in the network environment can be configured to connect to the communication network according to various wired and wireless communication protocols. Examples of such wired and wireless communication protocols may include, but are not limited to, at least one of the following: transmission control protocol and Internet protocol (TCP/IP), user datagram protocol (UDP), hypertext transmission protocol (HTTP), file transfer protocol (FTP), ZigBee, EDGE, IEEE 802.11, optical fidelity (Li Fi), 802.16, IEEE 802.11s, IEEE 802.11g, multi hop communication, wireless access point (AP), device to device communication, cellular communication protocol and/or Bluetooth communication protocol or a combination thereof.

Optionally, the server may also include a user interface, which may include a display, an input unit such as a keyboard, and optional user interfaces may also include standard wired and wireless interfaces. Optionally, in some embodiments, the display may be an LED display, a liquid crystal display, a touch sensitive liquid crystal display, and an OLED (Organic Light Emitting Diode) touch sensor, among others. Among them, the display can also be referred to as a screen or display unit, used to display the information processed in server 1 and to display the visual user interface.

FIG. 1 only shows server 1 with components 11-13 and a falling bed warning program 10 based on millimeter wave radar. Those skilled in the art can understand that the structure shown in FIG. 1 does not constitute a limitation on server 1, and may include fewer or more components than shown in the figure, or combine certain components, or arrange different components.

In this embodiment, processor 12 can be used to call the millimeter wave radar based falling bed warning program stored in memory 11 and perform the following operations:
Receive echo signals in space and calculate point cloud data of the monitoring object based on the echo signals;
Determine whether the monitoring object has a tendency to move towards the outside of the bed based on the point cloud data;
Determine whether the monitoring object is in the preset falling bed warning position based on the point cloud data;
If the monitoring object has a tendency to move towards the edge of the bed and is in the preset falling bed alarm position, execute the set falling bed warning instruction.

In one embodiment, processor 12 can be used to call the millimeter wave radar based falling bed warning program stored in memory 11 and perform the following operations:
Convert the echo signal into a digital signal;
Perform distance dimension fast Fourier transform and Doppler dimension Fourier transform on the digital signal to obtain the distance Doppler spectra of all target units in the space;
Perform incoherent accumulation on the distance Doppler spectrum and use preset threshold parameters to perform two-dimensional constant false alarm detection on the accumulated results, in order to extract the corresponding target units of the monitoring object on the distance Doppler spectrum;
Perform joint azimuth elevation angle measurement on the target unit corresponding to the monitoring object to obtain the azimuth and elevation angles of the target unit;
Obtain point data corresponding to the target unit in space based on the azimuth and elevation angles, as well as the corresponding distance units on the range Doppler spectrum;

Generate point cloud data for the monitoring object based on all point data of the monitoring object.

In one embodiment, processor 12 can be used to call the millimeter wave radar based falling bed warning program stored in memory 11 and perform the following operations:
Cluster and fuse the point cloud data of the monitoring object to obtain the fitting center of the monitoring object in space;
Perform Kalman filtering tracking on the fitting center to obtain the historical movement trajectory of the monitoring object;
Determine whether the monitoring object has a tendency to move towards the outside of the bed based on the historical movement trajectory.

In one embodiment, processor 12 can be used to call the millimeter wave radar based falling bed warning program stored in memory 11 and perform the following operations:
Calculate the distance between the monitoring object and the designated boundary of the bed based on the historical movement trajectory;
Determine whether the monitoring object is moving towards the designated boundary of the bed based on the distance provided;
If the monitoring object continuously or intermittently moves towards the designated boundary of the bed within a set time, and the movement distance exceeds the preset distance threshold, it is determined that the monitoring object has a tendency to move towards the outside of the bed.

In one embodiment, processor 12 can be used to call the millimeter wave radar based falling bed warning program stored in memory 11 and perform the following operations:
Calculate the number of monitoring points located within the falling bed warning area in the point cloud data of the monitoring object;
Calculate the ratio of the number of monitoring points located within the falling bed warning area to the total number of monitoring points in the point cloud data of the monitoring object, and compare the ratio with a preset threshold; If the ratio is greater than or equal to the preset threshold, it is determined that the monitoring object is currently in the preset falling bed alarm position.

In one embodiment, processor 12 can be used to call the millimeter wave radar based falling bed warning program stored in memory 11 and perform the following operations:
Receive user instructions through a preset user graphical interface, including instructions for setting the boundary of the bed and instructions for setting the warning area for falling beds;
Based on the received user instructions, specify the boundary of the bed in the space and delineate a falling bed warning area within the boundary of the bed.

In one embodiment, processor 12 can be used to call the millimeter wave radar based falling bed warning program stored in memory 11 and perform the following operations:
Determine whether the monitoring object has experienced a bed falling event based on its point cloud data;
If a falling bed event is detected in the monitored object, execute the set falling bed alarm command.

In one embodiment, processor 12 can be used to call the millimeter wave radar based falling bed warning program stored in memory 11 and perform the following operations:
Executing the set falling bed warning command includes sending falling bed warning information to pre bound users; And/or
Executing the set falling bed alarm command includes sending falling bed alarm information to pre bound users.

Based on the hardware architecture of the falling bed warning system based on millimeter wave radar mentioned above, an embodiment of the falling bed warning method based on millimeter wave radar in the present invention is proposed. The falling bed warning method based on millimeter wave radar of the present invention aims to achieve all-weather and non-contact falling bed warning monitoring.

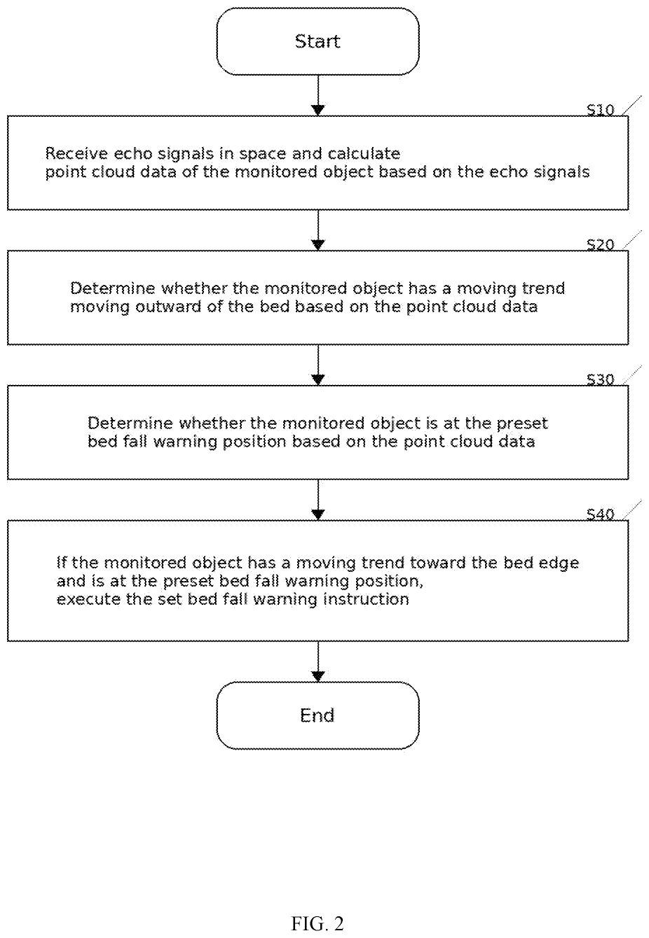

Referring to FIG. 2, FIG. 2 shows an embodiment of a falling bed warning method based on millimeter wave radar according to the present invention. The falling bed warning method based on millimeter wave radar includes the following steps:
S10. Receive echo signals in space and calculate point cloud data of the monitoring object based on the echo signals.

Among them, the monitoring object refers to the subject that needs to be monitored, monitored, and protected. For example, the monitoring object can be one of the following: patients, elderly people, or infants. Point cloud data is a set of discrete three-dimensional coordinate points used to describe the shape and position of an object in space.

It is worth noting that due to the small movements of the chest and chest caused by human respiration and heartbeat, these movements can cause periodic phase changes in the echo signal. Based on this periodic phase change, radar systems can set certain filtering conditions to distinguish between monitoring objects in space and stationary backgrounds, thereby accurately monitoring and tracking the position and motion of monitoring objects.

Specifically, millimeter wave radar systems first send millimeter wave signals, which interact with objects in space (usually people or objects in bed) and reflect back. The receiver receives these echo signals and uses their time delay and intensity information to calculate the point cloud data of the monitored object.
S20 Determine whether the monitoring object has a tendency to move towards the outside of the bed based on the point cloud data.

Specifically, by analyzing the point cloud data of the monitoring object, the position of the monitoring object in space can be obtained over time. Based on this change, the system can further analyze the speed and direction of the position change of the monitoring object, and thus obtain the movement trend of the monitoring object.

For example, when the monitored object moves towards the edge of the bed, the system will determine that the monitored object has a tendency to move towards the outside of the bed. On the contrary, if the monitored object maintains a basically unchanged position or moves away from the edge of the bed, the system will determine that the monitored object does not have a tendency to move towards the outside of the bed.

It is worth noting that the placement of the bed may vary depending on different environments, such as placing it against the wall on one side or against the wall on both sides. In this case, the system needs to consider the specific layout of the bed and determine whether there is a risk of falling off the bed based on the position of the monitoring object relative to the bed. For example, when the monitoring object moves towards the edge of the bed on the wall side, the system does not determine that the monitoring object has a tendency to move towards the outside of the bed.
S30. Determine whether the monitoring object is in the preset falling bed warning position based on the point cloud data.

Among them, the falling bed alarm position refers to a pre-set virtual area used to determine whether the monitored object is at risk of falling from the bed.

Optionally, the falling bed warning location can be the edge area of the bed or the middle area of the bed. The difference between these two is that for the falling bed warning position set in the edge area of the bed, when most of the monitored object's body enters the edge area, it can be considered that the monitored object is currently in the preset falling bed warning position. For the falling bed warning position located in the middle area of the bed, when most of the monitored object's body leaves the middle area, it can be considered that the monitored object is currently in the preset falling bed warning position.

Specifically, the system will compare the point cloud data of the monitored object with the preset falling bed warning position to determine whether the monitored object is in the preset falling bed warning position.
S40. If the monitoring object has a tendency to move towards the edge of the bed and is in the preset falling bed alarm position, execute the set falling bed warning instruction.

Specifically, when the monitored object has a tendency to move towards the outside of the bed and is currently in the preset falling bed warning position, the system will consider that the monitored object currently has a high risk of falling from the bed and execute the set falling bed warning command.

Among them, the falling bed warning instruction set includes sending falling bed warning information to pre bound users. This can be achieved through app notifications, text messages, phone calls, emails, or other communication methods. And the bed fall warning information can include text or voice information such as the name, room number, bed number, and occurrence time of the monitored object. The pre bound users can be nursing staff, family members, medical staff, or other related personnel.

In addition, the falling bed warning command can also be a system that sends sound, light, or vibration signals to the monitored object.

In some embodiments, after sending the bed fall warning information, if no reply or confirmation message is received from the pre bound user based on the bed fall warning information, the system will repeatedly send the same message until a reply or confirmation message is received or the preset number of times is reached.

It can be understood that the technical solution of the present application is based on a millimeter wave radar for bed fall warning method. The point cloud data of the monitoring object is obtained through the radar to calculate the monitoring movement trend and current position. When the monitoring object has a movement trend towards the outside of the bed and is in the bed fall warning position, it is determined that there is a risk of bed fall and the bed fall warning instruction is executed, thereby achieving bed fall warning of the monitoring object. Therefore, compared to the traditional solution of detecting bed falls through smart wearable devices, the technical solution of this application has the following advantages:
1. Privacy protection: Unlike cameras, millimeter wave radar does not generate images during monitoring, but only captures simple trajectories and point cloud data. This means that the privacy of the monitored object has been effectively protected and will not touch upon personal privacy issues. This makes the bed fall detection system very suitable for private places such as bedrooms and wards.
2. 24/7 monitoring: Millimeter wave radar can monitor under all weather conditions, without being limited by light, temperature, or weather conditions. This makes the bed fall detection system highly suitable for people who require round the clock monitoring, such as the elderly and children.
3. Contactless monitoring: The system uses millimeter wave radar for contactless monitoring, without the need for monitoring objects to wear special equipment. This reduces the burden on users, especially for the elderly and children who do not need to wear additional smart devices.
4. High recognition accuracy: At the same time, the monitoring object's risk of falling from the bed can be determined by the movement trend and the location of the falling bed warning, which can minimize the probability of false alarms and improve the accuracy of the falling bed warning.
5. Easy installation: The installation of millimeter wave radar is very convenient, it can be installed on the top of the ceiling or at the head of the bed, and the setup is simple. This allows users to easily deploy the system without the need for complex installation processes, reducing barriers to use.

In some embodiments, calculating the point cloud data of the monitoring object based on the echo signal comprises the following steps:
S11. Convert the echo signal into a digital signal.

Specifically, the echo signals returned by objects in space are analog signals, which need to be converted into digital signals through an analog-to-digital conversion module (ADC) before further processing.
S12. Perform Range FFT and Doppler FFT on the digital signal to obtain the Range Doppler map (RD map) of all virtual channels of the radar.

Among them, in radar signal processing, the distance dimension is used to measure the distance between the target object and the radar, and the Doppler dimension is used to measure the velocity of the target object. Virtual channel is a technology in MIMO radar that can form a Nyquist virtual array at the receiving end, greatly improving the effective aperture of the array and enhancing the detection capability of the radar.

Furthermore, Range FFT is a method of measuring target distance by utilizing the relationship between the frequency variation of the chirp signal and the target distance. Doppler FFT is a method of measuring target velocity by utilizing the relationship between the frequency change of the echo signal caused by target motion and the target velocity.

In this embodiment, the system first performs Range FFT on each antenna of the radar to obtain distance information for all virtual channels/antennas of the radar. Perform Doppler FFT on the results of Range FFT to obtain Doppler dimension data for each virtual channel/virtual antenna. By combining the Range FFT results with the Doppler FFT results, the RD map for each virtual channel/virtual antenna can be obtained.
S13. Non coherent accumulation is performed on the distance Doppler spectra of all virtual channels, and a preset threshold parameter is used to perform 2D Constant False Alarm Rate Detector (2D CFAR) on the accumulated results, in order to extract the corresponding target units of the monitoring object on the distance Doppler spectra.

Among them, after obtaining the RD maps of each virtual channel/virtual antenna, non coherent accumulation can be performed on all the RD maps of virtual channels/virtual antennas to obtain the accumulated RD maps. Non coherent accumulation is a method of adding the RD maps of different antennas or frames based on their amplitudes without considering phase differences. Non coherent accumulation can improve the signal-to-noise ratio of the target unit, making it easier to detect the target unit during the subsequent two-dimensional constant false alarm detection steps.

Furthermore, 2D CFAR detection is a method of constant false alarm detection in both distance and Doppler dimensions, which can determine the presence of a target unit based on the average value of each unit and surrounding units in the RD map.

Specifically, the preset threshold parameter is the false alarm rate threshold required for 2D CFAR detection. A two-dimensional threshold decision is made on the accumulated distance Doppler data, and targets corresponding to data points exceeding the threshold value are considered as existing targets. Therefore, after completing 2D CFAR detection, target units in space can be filtered out.
S14. Perform joint azimuth elevation angle measurement on the target unit corresponding to the monitoring object to obtain the azimuth and elevation angles of the target unit.

Among them, azimuth and elevation angles are parameters used to describe the position of the target unit in the radar detection space. They are angle measurements in polar coordinate systems used to determine the direction and elevation angle of the target object relative to the radar. The azimuth describes the horizontal direction of the target unit relative to the radar position. The pitch angle describes the vertical direction of the target unit relative to the radar position.

The azimuth elevation joint angle measurement algorithm is a method used to calculate the azimuth and elevation angles of a target object in the radar detection space. The core principle of the azimuth elevation joint angle measurement algorithm is to use multiple antennas or sensors to measure the signals of the target object, and combine the phase and amplitude information of these signals to calculate the azimuth and elevation angles.

Specifically, after selecting the target unit, all antenna data of the target unit can be extracted from the RD map. Then, the azimuth elevation joint angle measurement algorithm is used to calculate the azimuth and elevation angles of the target unit.
S15. Based on the azimuth and elevation angles, as well as the corresponding distance and Doppler units on the distance Doppler spectrum, obtain the point data of the target unit in space.

Specifically, after calculating the azimuth and elevation angles of the target unit, combined with the distance and Doppler units recorded in the RD map, the three-dimensional position of the target unit in the radar detection space can be determined, and then the point data of the target unit can be obtained.
S16. Generate point cloud data of the monitoring object in space based on all point data of the monitoring object.

Specifically, by monitoring the point data of all monitoring points of the object, the point cloud data of the monitoring object can be obtained.

In this way, point cloud data of the monitoring object can be extracted from the echo signal through steps S11 to S16, in order to achieve monitoring of the movement and position of the monitoring object.

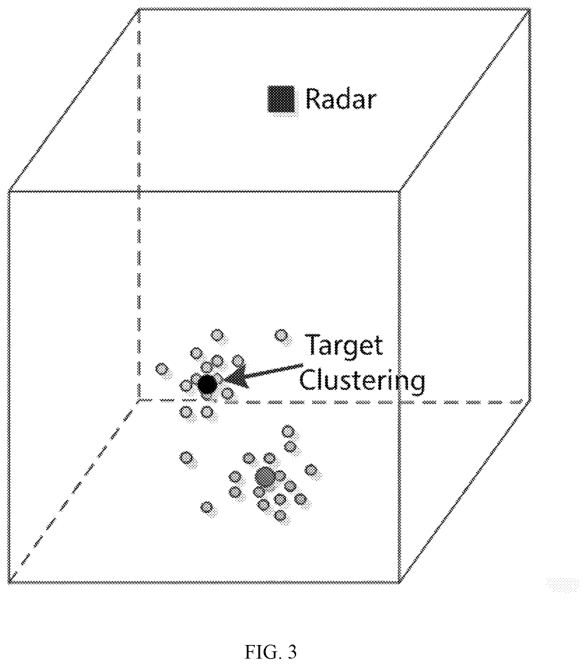

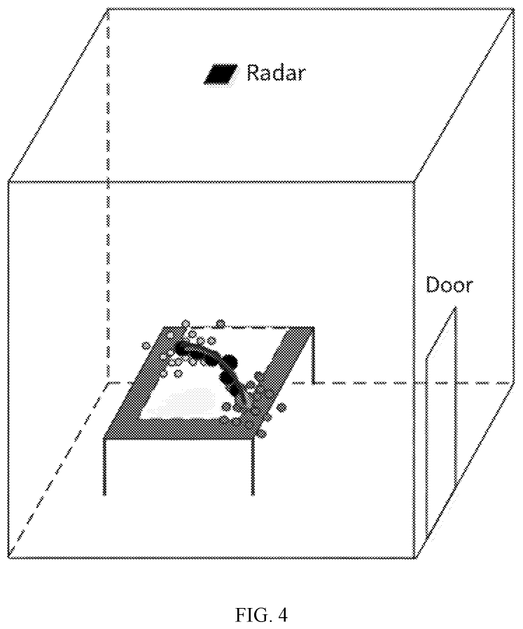

Please refer to FIGS. 3 and 4. In some embodiments, determining whether the monitoring object has a tendency to move towards the outside of the bed based on the point cloud data includes the following steps:
S21. Cluster and fuse the point cloud data of the monitoring object to obtain the fitting center of the monitoring object in space.

Specifically, the point cloud data of the monitoring object can be clustered and fused, and then the least squares method can be used for spherical fitting. Obtain the centroid coordinates of the clustering results, and then use these centroid coordinates as the fitting center of the monitoring object in space.

Among them, spherical fitting is a mathematical method used to find the parameters of a sphere that are most suitable for a set of data points, including the center coordinates and radius of the sphere.
S22. Perform Kalman filtering tracking on the fitting center to obtain the historical movement trajectory of the monitoring object.

Among them, Kalman filtering is an algorithm that uses linear system state equations to estimate the optimal state of a system through input-output observation data. By tracking the coordinates of the fitting center through Kalman filtering, the changes in the coordinates of the fitting center over time can be obtained.

Specifically, by tracking the coordinates of the fitting center through Kalman filtering, the coordinates of the fitting center at each sampling moment can be obtained, and the changes in the coordinates of the fitting center over time can be obtained, generating the historical movement trajectory of the monitoring object.
S23. Determine whether the monitoring object has a tendency to move towards the outside of the bed based on the historical movement trajectory.

Specifically, based on the historical movement trajectory of the monitored object, the system can determine whether the monitored object has a tendency to move towards the outside of the bed. This can be achieved by analyzing the direction and speed of the trajectory. For example, if the historical trajectory of the monitored object indicates that it is gradually approaching the edge of the bed, the system will determine that it has a tendency to move towards the outside of the bed.

It can be understood that by clustering the point cloud data of the monitoring object to obtain a fitting center, and using this fitting center to determine the movement trend of the monitoring object, compared to directly calculating point cloud data, this reduces the amount of data required for calculation, reduces computational complexity, and can significantly reduce the demand for computing resources (especially when processing a large amount of point cloud data). Moreover, since only the fitting center needs to be processed instead of the position of each point, the calculation speed will be significantly improved, which helps to enhance the response speed of falling bed warning.

In addition, point cloud data often contains a certain degree of noise, and through clustering and fitting center calculations, the impact of noise on motion trend calculations can be reduced. This improves the accuracy of the calculation results.

Please continue to refer to FIG. 4. In some embodiments, based on the historical movement trajectory, it is determined whether the monitoring object has a movement trend towards the outside of the bed, including:
S231. Calculate the distance between the monitoring object and the designated boundary of the bed based on the historical movement trajectory.

Among them, the designated boundary of the bed refers to the pre-defined edge or boundary position of the bed. This boundary is usually a virtual line used to indicate the edge position of the bed, and any boundary beyond it is considered the outer side of the bed.

Specifically, the designated boundary of the bed can be defined and set according to specific monitoring system requirements and scenarios. In general, it is usually a virtual line parallel to the edge of the bed, which can be set along the edge of the bed or a specific edge of the bed (such as one side of the bed).

Optionally, the designated boundary of the bed can be one side, two sides, three sides, or even four sides of the bed.

It is worth noting that different designated boundaries may need to be set depending on the layout of the bed in the room (e.g. the head of the bed against the wall or both sides against the wall). In addition, users or system operators can customize the location of designated boundaries according to specific needs to ensure that the monitoring system provides accurate bed fall warnings in specific situations.

Specifically, the system can calculate the distance between the monitoring object and the designated boundary of the bed by measuring the distance between the fitting center coordinates of the monitoring object and the bed boundary.
S232. Determine whether the monitoring object is moving towards the designated boundary of the bed based on the distance.

Specifically, based on the calculated spacing, it can be determined whether the monitoring object is moving towards the designated boundary of the bed. This can be achieved by comparing the direction and magnitude of changes in spacing over time. If the designated distance between the monitoring object and the bed gradually decreases, it can be considered that the monitoring object is moving towards the designated boundary of the bed.
S233. If the monitoring object continuously or intermittently moves towards the designated boundary of the bed within a set time, and the movement distance exceeds the preset distance threshold, it is determined that the monitoring object has a tendency to move towards the outside of the bed. Specifically, based on the spacing obtained in step S232, the system can determine whether the monitored object is continuously or intermittently moving towards the designated boundary of the bed within a set time (e.g., a few minutes or seconds), as well as the distance traveled by the monitored object within the specified time.

When the monitored object continuously or intermittently moves towards the designated boundary of the bed within a set time, and the movement distance exceeds the preset distance threshold, the system will determine that the monitored object has a tendency to move towards the outside of the bed.

It can be understood that through the above steps S231 to S233, not only can the direction of movement of the monitoring object be obtained, but also the probability of misjudgment can be reduced through the distance threshold, improving the accuracy of judging the movement trend of the monitoring object.

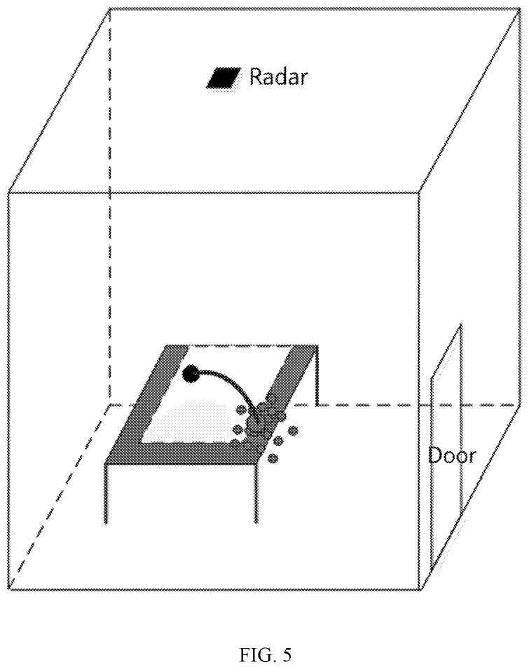

Please refer to FIG. 5. In some embodiments, a falling bed warning area is pre-set at the boundary of the bed. Among them, the falling bed warning area refers to a predefined virtual area near the edge of the bed. This virtual area is used to determine whether the monitored object is in a potential risk position of falling from the bed.

Specifically, the warning area for falling beds is usually located on the side of the bed that is not in contact with walls, storage cabinets, or other obstructions. The specific location needs to be adjusted according to the actual layout of the bed. In addition, the size and shape of the falling bed warning area can be preset by the system or customized according to user requirements.

Furthermore, based on the point cloud data, determine whether the monitoring object is in the preset falling bed alarm position, including:
S31. Calculate the number of monitoring points located within the falling bed warning area in the point cloud data of the monitoring object.

Specifically, based on a predefined definition, the system can know the boundary coordinates of the falling bed warning area. Based on the boundary coordinates of the falling bed warning area and the point cloud data of the monitoring object in the current frame, the number of monitoring points located within the falling bed warning area in the point cloud data of the monitoring object can be obtained by comparing the coordinates of each point in the point cloud data of the monitoring object in the current frame with the boundary coordinates of the falling bed warning area.
S32. Calculate the ratio of the number of monitoring points located within the falling bed warning area to the total number of monitoring points in the point cloud data of the monitoring object, and compare the ratio with a preset threshold.

Specifically, based on the point cloud data of the monitoring object, the total number of monitoring points representing the monitoring object can be directly obtained. So, after obtaining the number of monitoring points located within the falling bed warning area, we can further calculate their ratio to the number of chief monitoring points. This ratio represents the degree to which the monitored object's body occupies the falling bed warning area. By comparing this ratio with the preset threshold, it is possible to further determine whether the monitoring object is currently in the falling bed warning position.

Among them, the preset threshold can be set by the system or customized for the monitoring object. For example, when the monitoring object is a baby, a relatively larger preset threshold can be set; When the monitoring object is the elderly, a standard preset threshold can be set; When the monitoring object is an adult patient, the monitoring object can be set relatively smaller.

Optionally, we can set the preset threshold to any data between 0.4 and 0.7.
S33. If the ratio is greater than or equal to the preset threshold, it is determined that the monitoring object is currently in the preset falling bed alarm position.

Specifically, if the calculated ratio is greater than or equal to the preset threshold, the system will determine that the monitored object is currently in the preset falling bed alarm position. This indicates that the monitoring object is currently close enough to the edge of the bed, and it can be considered that the monitoring object is in the position of falling bed warning.

Through the above steps, the system can determine whether the monitoring object is located at the preset falling bed alarm position based on the monitoring points in the point cloud. Compared to the method of determining whether the monitoring object is in the falling bed warning position by fitting the center, this approach is more accurate and safer, and can timely detect whether the monitoring object is in the falling bed warning position.

In some embodiments, before determining whether the bedridden patient is in the preset falling bed alarm position based on point cloud data, the method further comprises the following steps:
S110. Receive user instructions through a preset user graphical interface, including instructions for setting the boundary of the bed and instructions for setting the warning area for falling beds.

Among them, the preset graphical user interface refers to the interactive interface provided by the monitoring system or application to the user. This interface can take various forms, including but not limited to WeChat mini program interface, mobile client interface, computer client interface, web interface, etc. This graphical user interface allows users to interact with the monitoring system and make various settings and configurations to meet their monitoring needs.

Specifically, the boundary setting instruction for the bed is used to set the specific position and size of the bed in a space (usually a room). Users can select or mark the boundaries of the bed by dragging, clicking, and other operations in the preset graphical user interface.

Specifically, the instruction for setting the falling bed warning area is used to delineate a specific area within the boundary of the bed to monitor and determine whether the monitored object is in the falling bed alarm position. Users can select, draw, and set parameters through the preset graphical user interface to determine the boundaries of the falling bed warning area.
S120. Based on the received user instructions, specify the boundary of the bed in the space and delineate a falling bed warning area within the boundary of the bed.

Specifically, based on the received user instructions, the system will specify the boundaries of the bed and the warning area for falling beds in the space.

Through the above steps, users can set the boundary of the bed and the boundary of the falling bed warning area, which can be customized according to the actual scene and needs, with higher degrees of freedom.

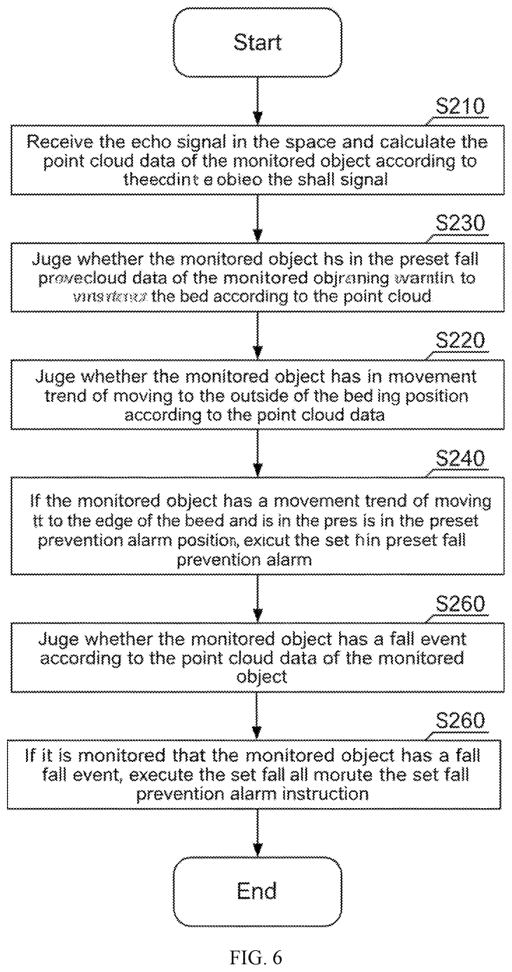

As shown in FIG. 6, in some embodiments, after executing the set falling bed warning command, the method further comprises the following steps:
S250. Determine whether the monitoring object has experienced a bed falling event based on the point cloud data of the monitoring object.

Optionally, in some embodiments, the number of monitoring points located outside the bed boundary in the point cloud data of the monitoring object can be calculated as a ratio to the total number of monitoring points in the point cloud data, and this ratio can be compared to a set threshold to determine whether the monitoring object has experienced a bed fall event. Specifically, when the above ratio is greater than or equal to the set threshold, it can be determined that the monitoring object has experienced a bed falling event.

In other embodiments, the number of points located outside the bed boundary in the point cloud data of the monitoring object can be compared with a set threshold to determine whether the monitoring object has experienced a bed falling event. Specifically, when the number of monitoring points located outside the bed boundary is greater than or equal to the set threshold, it can be determined that the monitoring object has fallen off the bed.

In some embodiments, when the point cloud data of the monitoring object meets the following conditions simultaneously, the system will determine that the monitoring object has experienced a bed falling event:
1. When the fitting center of the point cloud data of the monitoring object is outside the bed boundary;
2. The height of the fitting center is lower than the height of the bed;
3. Most point clouds in point cloud data (such as monitoring points with a proportion greater than or equal to 60%) are distributed outside the bed boundary;
4. The average height of the point cloud is relatively low (e.g. below the height of the bed);
5. There is a sudden change in the velocity of point cloud motion, which is manifested by a sharp increase in the average velocity of the point cloud or the velocity of the fitting center, followed by a sudden decrease.
S260. If a falling bed event is detected in the monitored object, execute the set falling bed alarm command.

Specifically, when the monitored object experiences a falling bed event, the radar system will generate the falling bed event and upload it to the cloud platform. At the same time, the system or cloud platform will execute the set falling bed alarm command and issue an alarm.

Among them, the falling bed alarm command set includes sending falling bed alarm information to pre bound users. This can be achieved through app notifications, text messages, phone calls, emails, or other communication methods. The falling bed alarm information can include text or voice information such as the name, room number, bed number, and occurrence time of the monitored object. The pre bound users can be nursing staff, family members, medical staff, or other related personnel.

In addition, the falling bed alarm command can also be a prompt signal sent by the system to the monitored object, such as sound, light, or vibration.

In some embodiments, after sending the falling bed alarm information, if no reply or confirmation message is received from the pre bound user based on the falling bed alarm information, the system will repeatedly send the same message until a reply or confirmation message is received or the preset number of times is reached.

Through the above steps, the system can quickly respond and take appropriate actions to ensure the safety of the monitored object when it falls off the bed.

In addition, the radar system of the present technical solution can also be equipped with microphones and speakers, which enables the system to have two-way voice communication function. In this way, once a bed falling incident occurs, the system can actively initiate communication requests with the bound user and achieve two-way voice calls after communication is established. In this way, the monitored object can receive timely communication and assistance, which helps to provide rapid rescue or support in emergency situations.

In addition, the embodiments of the present invention also propose a computer-readable storage medium, which may be a hard disk, a multimedia card, an SD card, a flash memory card SMC. Any one or any combination of read-only memory (ROM), erasable programmable read-only memory (EPROM), portable compact disc read-only memory (CD-ROM), USB memory, etc. The computer-readable storage medium includes a falling bed warning program 10 based on millimeter wave radar. The specific implementation of the computer-readable storage medium of the present invention is roughly the same as the above-mentioned falling bed warning method based on millimeter wave radar and the specific implementation of server 1, and will not be repeated here.

Technicians in this field should understand that embodiments of the present invention can be provided as methods, systems, or computer program products. Therefore, the present invention can be implemented in the form of a fully hardware implementation, a fully software implementation, or a combination of software and hardware aspects. Moreover, the present invention may take the form of a computer program product implemented on one or more computer usable storage media (including but not limited to disk storage, CD-ROM, optical storage, etc.) containing computer usable program code.

The present invention is described with reference to flowcharts and/or block diagrams of methods, devices (systems), and computer program products according to embodiments of the present invention. It should be understood that each process and/or block in the flowchart and/or block diagram, as well as the combination of processes and/or blocks in the flowchart and/or block diagram, can be implemented by computer program instructions. These computer program instructions can be provided to a processor of a general-purpose computer, specialized computer, embedded processor, or other programmable data processing device to generate a machine, such that the instructions executed by the processor of the computer or other programmable data processing device generate a device for implementing the functions specified in one or more processes in the flowchart and/or one or more boxes in the block diagram.

These computer program instructions can also be stored in computer-readable memory that can guide a computer or other programmable data processing device to operate in a specific manner, causing the instructions stored in the computer-readable memory to produce a manufactured product including instruction devices that implement the functions specified in a flowchart or multiple flowcharts and/or a block diagram or multiple boxes.

These computer program instructions can also be loaded onto a computer or other programmable data processing device, enabling a series of operational steps to be executed on the computer or other programmable device to generate computer implemented processing. The instructions executed on the computer or other programmable device provide steps for implementing the functions specified in one or more processes in the flowchart and/or one or more boxes in the block diagram.

Although preferred embodiments of the present invention have been described, those skilled in the art may make additional changes and modifications to these embodiments once they have knowledge of the basic inventive concept. Therefore, the attached claims are intended to be interpreted as including preferred embodiments and all changes and modifications falling within the scope of the present invention.

Obviously, technicians in this field can make various modifications and variations to the present invention without departing from the spirit and scope of the invention. Thus, if these modifications and variations of the present invention fall within the scope of the claims and their equivalent technologies, the present invention is also intended to include these modifications and variations.

What is claimed is:

1. A falling bed warning method based on millimeter wave radar, characterized by comprising:
Receive echo signals in space and calculate point cloud data of the monitoring object based on the echo signals;
Determine whether the monitoring object has a tendency to move towards the outside of the bed based on the point cloud data;
Determine whether the monitoring object is in the preset falling bed warning position based on the point cloud data;
If the monitoring object has a tendency to move towards the edge of the bed and is in the preset falling bed alarm position, execute the set falling bed warning instruction.

2. The falling bed warning method based on millimeter wave radar as claimed in claim 1, characterized in that the point cloud data of the monitoring object is calculated based on the echo signal, comprising:
Convert the echo signal into a digital signal;
Perform distance dimension fast Fourier transform and Doppler dimension Fourier transform on the digital signal to obtain the distance Doppler spectra of all virtual channels of the radar;
Perform incoherent accumulation on the distance Doppler spectra of all virtual channels, and use preset threshold parameters to perform two-dimensional constant false alarm detection on the accumulated results, in order to extract the corresponding target units of the monitoring object on the distance Doppler spectra;
Perform joint azimuth elevation angle measurement on the target unit corresponding to the monitoring object to obtain the azimuth and elevation angles of the target unit;
Obtain point data corresponding to the target unit in space based on the azimuth and elevation angles, as well as the corresponding distance units on the range Doppler spectrum;
Generate point cloud data for the monitoring object based on all point data of the monitoring object.

3. The falling bed warning method based on millimeter wave radar as claimed in claim 1, characterized in that, based on the point cloud data, it is determined whether the monitoring object has a movement trend towards the outside of the bed, comprising:
Cluster and fuse the point cloud data of the monitoring object to obtain the fitting center of the monitoring object in space;
Perform Kalman filtering tracking on the fitting center to obtain the historical movement trajectory of the monitoring object;
Determine whether the monitoring object has a tendency to move towards the outside of the bed based on the historical movement trajectory.

4. The falling bed warning method based on millimeter wave radar as claimed in claim 3, characterized in that it determines whether the monitored object has a movement trend towards the outside of the bed based on the historical movement trajectory, comprising:
Calculate the distance between the monitoring object and the designated boundary of the bed based on the historical movement trajectory;
Determine whether the monitoring object is moving towards the designated boundary of the bed based on the distance provided;
If the monitoring object continuously or intermittently moves towards the designated boundary of the bed within a set time, and the movement distance exceeds the preset distance threshold, it is determined that the monitoring object has a tendency to move towards the outside of the bed.

5. The falling bed warning method based on millimeter wave radar as claimed in claim 1, characterized in that a falling bed warning area is pre-set at the boundary of the bed;
Judging whether the monitoring object is in the preset falling bed alarm position based on the point cloud data, including:
Calculate the number of monitoring points located within the falling bed warning area in the point cloud data of the monitoring object;
Calculate the ratio of the number of monitoring points located within the falling bed warning area to the total number of monitoring points in the point cloud data of the monitoring object, and compare the ratio with a preset threshold; If the ratio is greater than or equal to the preset threshold, it is determined that the monitoring object is currently in the preset falling bed alarm position.

6. The falling bed warning method based on millimeter wave radar as claimed in claim 5, characterized in that before determining whether the bedridden patient is in the preset falling bed alarm position based on point cloud data, the method further comprises:
Receive user instructions through a preset user graphical interface, including instructions for setting the boundary of the bed and instructions for setting the warning area for falling beds;
Based on the received user instructions, specify the boundary of the bed in the space and delineate a falling bed warning area within the boundary of the bed.

7. The falling bed warning method based on millimeter wave radar as claimed in claim 1, characterized in that, after executing the set falling bed warning instruction, the method further comprises:
Determine whether the monitoring object has experienced a bed falling event based on its point cloud data;
If a falling bed event is detected in the monitored object, execute the set falling bed alarm command.

8. The falling bed warning method based on millimeter wave radar as claimed in claim 7, characterized in that:,
Executing the set falling bed warning command includes sending falling bed warning information to pre bound users; And/or
Executing the set falling bed alarm command includes sending falling bed alarm information to pre bound users.

9. A falling bed warning system based on millimeter wave radar, characterized by comprising a millimeter wave radar, a memory, a processor, and a falling bed warning program based on millimeter wave radar stored on the memory and executable on the processor; When the processor executes the falling bed warning program based on millimeter wave radar, it implements the falling bed warning method based on millimeter wave radar as claimed in claim 1.

10. A computer-readable storage medium, characterized in that the computer-readable storage medium stores a falling bed warning program based on millimeter wave radar, and when the falling bed warning program based on millimeter wave radar is executed by a processor, it implements the falling bed warning method based on millimeter wave radar as claimed in claim 1.
